(19) United States
(12) Patent Application Publication
(10) Pub. No.: US 2025/0344029 A1
(43) Pub. Date: Nov. 6, 2025

(54) FAULT DETECTION AND MICROPHONE SWITCHING FOR AUDIO DEVICES

(71) Applicant: Apple Inc., Cupertino, CA (US)

(72) Inventors: Caleb RAU, San Francisco, CA (US); Esge B. ANDERSEN, Campbell, CA (US); Jakub MAZUR, Daly City, CA (US); Jianjun HE, San Jose, CA (US); Mark P. NOON, San Jose, CA (US)

(21) Appl. No.: 19/084,729

(22) Filed: Mar. 19, 2025

Related U.S. Application Data
(60) Provisional application No. 63/643,367, filed on May 6, 2024.

(51) Int. Cl. H04R 29/00; H04R 3/00

(52) U.S. Cl. CPC H04R 29/004; H04R 3/00

(57) ABSTRACT

Aspects of the subject technology provide for fault detection and microphone switching of audio device(s) in an audio system. In some implementations, a preferred microphone can be determined to be in a fault condition. In response to such determination, a selection of another microphone of the audio system can be initiated to become the preferred microphone.

### CROSS REFERENCE TO RELATED APPLICATIONS

This application claims the benefit of U.S. Provisional Application No. 63/643,367, entitled “FAULT DETECTION AND MICROPHONE SWITCHING FOR AUDIO DEVICES,” filed May 6, 2024, the entirety of which is incorporated herein by reference.

### TECHNICAL FIELD

The present description relates generally to audio input and output devices, including, for example, earbuds and audio headsets.

### BACKGROUND

Modern personal audio devices may include both a speaker and a microphone. In some cases, such as earbuds or an audio headset, the audio device may include multiple speakers and/or microphones for each ear, and an audio device may provide advanced features such as noise cancellation. The components of such audio devices may degrade over time, fail, or become exposed to detritus causing a degradation of performance.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an example audio system, in accordance with some implementations.

FIG. 2 illustrates an example audio device, in accordance with some implementations.

FIG. 3 illustrates an audio device testing environment, in accordance with some implementations.

FIG. 4 illustrates an audio device testing environment, in accordance with some implementations.

FIG. 5 illustrates a process flow for switching a preferred microphone of an audio system, in accordance with some implementations.

FIG. 6 illustrates a process flow for gating a fault condition, in accordance with some implementations.

FIG. 7 illustrates example transfer response data, in accordance with some aspects.

FIG. 8 illustrates an example computing device with which aspects of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Audio devices include various components, such as microphones and speakers which are used to provide corresponding functions for a user of the audio device. For example, the audio device may be a pair of wireless earbuds. The wireless earbuds may employ acoustic noise cancellation (ANC) using an external microphone to measure an ambient noise environment and provide a cancellation signal via a speaker to reduce the ambient noise reaching a user's ear drum. In another example, the wireless earbuds may be used for telephony and a microphone is used to pick up the user's voice and relay it to another device. In another example, the wireless earbuds may be used for music playback and a speaker is used for playing back music while a microphone is used to process voice commands which are passed to the music application.

In some implementations, the audio device may be organized as a pair of devices, such as a first earbud designed to be used in the user's left ear and a second earbud designed to be used in a user's right ear. An audio system may also include a case for holding the audio device, such as a case for storing and/or charging a pair of earbuds while not in use. In some instances, both the first device and second device may be wireless devices, while in other instances, the first device and second device may be wired together. The audio device may include one or more audio emitters (e.g., speakers) and one or more sensors (e.g., microphones). For example, each of the first earbud and second earbud may include a speaker, an inner microphone (mic), and one or more outer mics, such as an outer mic configured to capture an ambient audio environment and an outer mic configured to capture vocals in the audio environment, such as vocals from the user. The audio device may be paired with another device acting as a control device, such as a phone, tablet, or computer. Depending on the use of the audio device, the control device may prefer one microphone over another on the first earbud or on the second earbud due to the audio response characteristics of the preferred microphone and/or placement of the preferred microphone.

In other implementations, the audio device may include various components of an audio system of another style of headphones, a head mounted display, a phone, a tablet, a computer, and so forth.

Components may degrade over time. Also, openings in the body of the audio device which allow sound into microphones or allow sound out of speakers may become fully or partially occluded with detritus, such as dirt or earwax, may become damaged or temporarily affected by water or moisture infiltration, or may be damaged or altered so that the shape of the opening changes the audio characteristics corresponding to the opening.

The subject technology may detect a fault condition in a microphone or other aspect of an audio system by an audio system test, while the audio system is not in use, by outputting a test signal on a speaker of the audio system and utilizing a microphone of the audio system to capture the test signal and measure an audio response of the captured test signal. The audio response or transfer function of the captured test signal may be compared against an expected audio response to determine if the performance of the microphone and/or speaker is sufficient for general use and/or a specific use of the audio system. The comparison may be made by comparing the transfer function using statistical analysis or by comparing the transfer function using one or more trained machine learning models. Where the audio device is a pair of earbuds, the audio system test may be performed while the earbuds are docked in a storage/charging case. The audio system test may include sensing by one or more mics, such as an inner mic, vocal outer mic, and ambient outer mic of each earbud an audio test signal from the speaker of the same earbud and/or speaker of the other earbud and/or a speaker of the storage/charging case. The audio system test may determine whether transfer functions captured at each of the mics indicate whether there is a fault condition with the acoustics of one or more aspects of the audio device, including for example, a fault condition with the speaker, mics, openings, vents, or body, of the audio device. Future use of the audio device may be altered, such as switching a preferred microphone to another microphone of the device, based on the result of the system audio test and detection of a fault condition.

Thus, the subject technology presents a solution for error detection related to the audio components of the audio device. The subject technology also provides a mechanism for determining a fault condition for components of the audio device and provides for microphone switching under various fault conditions to provide failover support from a preferred microphone to an alternative microphone. The subject technology advantageously prolongs device usability by providing a failover mechanism for underperforming components and by providing device health check that can be used to direct a user regarding the health status of their audio device.

It is appreciated that some aspects of the subject technology may account for and comply with various industry standards or regulations of governmental regulatory bodies, such as Food and Drug Administration (FDA) regulations relating to a human hearing test system requiring regular testing to ensure an audio device continues to meet particular requirements, e.g. ANSI S3.6 requirements for an audiometer (an audiometry test device). In another aspect, testing may be required for hearing compensation applications in order to meet hearing aid compliance standards, such as ANSI CTA 2051/ANSI S3.22.

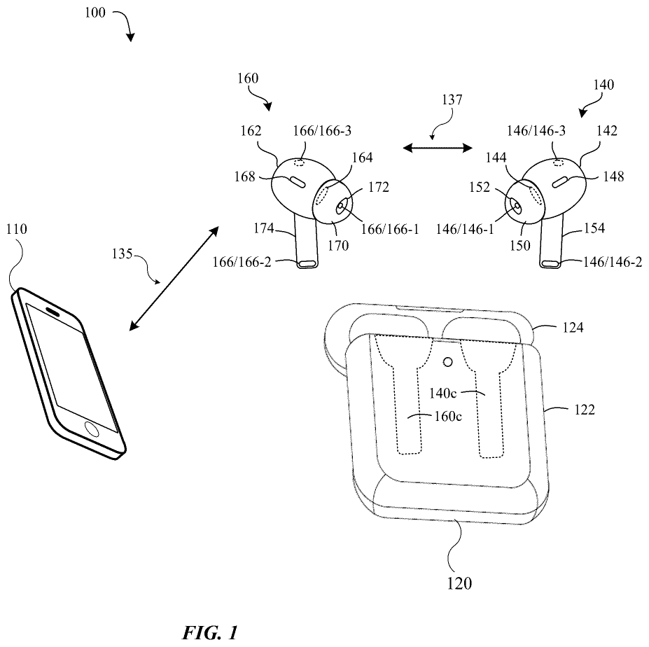

FIG. 1 illustrates an example audio system in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

In the example of FIG. 1, audio system 100 includes an electronic device 110, an audio device case 120, and the audio devices 140 and 160. Specifically, FIG. 1 illustrates an example of the audio system 100 implemented as an earbud or pair of earbuds. In this example, the earbuds are shaped for seating in the user's concha and/or aperture of the car canal and for interfacing with the user's ear canal. An optional cushion or sealing member may interface with the housing earbuds to provide a sealing effect between the audio devices 140 or 160 and the user's ear canal.

In some aspects, the electronic device 110 may be communicatively coupled to the audio device 140 and/or 160, such as demonstrated above via a wireless connection 135. Similarly, the audio device 140 may be communicatively coupled to the audio device 160 via a wireless connection 137. In some aspects, one of the audio devices 140 or 160 may be considered a primary device for coupling to the electronic device 110 and the other of the audio devices 140 or 160 may be considered a secondary device which is coupled to the electronic device via the primary device. In some aspects, the role of the audio devices 140 or 160 may switch such that the secondary becomes the primary and the primary becomes the secondary. In some aspects, both the audio device 140 and the audio device 160 are independently coupled to the electronic device 110.

In other aspects, the electronic device 110 may be communicatively coupled with the audio devices 140 and/or 160 via other methods and/or the audio devices 140 and 160 may be coupled to each other via other methods. For example, the electronic device 110 and audio devices 140 and/or 160 may couple via one or more wired connections. For example, one end of a wired connection may be (e.g., fixedly) connected to the audio device 140 and/or 160, while another end may have a connector, such as a media jack or a universal serial bus (USB) connector, which plugs into a socket of the electronic device 110.

The electronic device 110 may be configured to drive one or more speakers of the audio devices 140 and 160 with one or more audio signals via the wireless or wired connection.

The electronic device 110 may be any electronic device (e.g., with electronic components, such as one or more processors, memory, etc.) that is capable of streaming audio content, in any format, such as stereo audio signals, for playback (e.g., via one or more speakers integrated within the source device and/or via one or more output devices, as described herein). For example, the source device may be a desktop computer, a laptop computer, a digital media player, etc. In one aspect, the device may be a portable electronic device (e.g., being handheld operable), such as a tablet computer, a smart phone, etc. In another aspect, the source device may be a wearable device (e.g., a device that is designed to be worn on (e.g., attached to clothing and/or a body of) a user, such as a smart watch. In some aspects, the electronic device 110 may include an interface and programming contained in memory which when executed by the one or more processors performs a hearing test utilizing the electronic device 110.

The audio device case 120 may include a base 122 and a movable lid 124. The movable lid 124 may be hinged respective to the base 122 and may close over cavities 140c and 160c disposed in the base 122. The case 120 may provide storage for one or more audio devices, such as the audio devices 140 and/or 160, which may be fitted into the cavities 140c and/or 160c, respectively. The combination of the case and its corresponding audio device(s) may itself comprise an audio system which may also be considered part of the audio system 100 (e.g., including the electronic device 110). In an aspect, the audio device case 120 may provide storage for its corresponding audio device(s) when they are not in use by an audio device user, and may further enable maintenance features of audio devices, such as electrical charging of batteries in audio devices, and/or testing and validation of one or more of the audio devices, as explained further herein. In another aspect, case 120 may enable simultaneous charging and calibration of audio devices while stored in the case.

Each of the audio devices 140 and 160 may correspond to a combination of one or more emitter components; such as speakers; one or more sensor components, such as microphones; internal circuitry, such as processor(s), memory, antennas, and so forth; and a battery. In some instances, such as illustrated in FIG. 1, each of the audio devices 140 and 160 may correspond to a wireless earbud.

In the example of FIG. 1, with respect to the audio device 140, the audio device 140 may include a housing 142. The housing 142 may include one or more speakers 144 and one or more microphones 146, such as an inner mic 146-1, a lower outer mic 146-2, and an upper outer mic 146-1. Each of the one or more speakers 144 and microphones 146 may include corresponding openings through the housing 142, which each may be protected by a screen, in some implementations. A vent 148 may also be disposed in the housing 142. An optional car scaling member and cushion 150 may be disposed on an outer portion of the housing 142 and adjacent the one or more speakers 144. An opening 152 through the optional car sealing member and cushion 150 allows sound to pass through the opening 152 to a user's ear drum. A stem 154 may extend below a main portion of the housing 142.

With respect to the audio device 160, the audio device 160 may include a housing 162. The housing 162 may include one or more speakers 164 and one or more microphones 166, such as an inner mic 166-1, a lower outer mic 166-2, and an upper outer mic 166-1. Each of the one or more speakers 164 and microphones 166 may include corresponding openings through the housing 162, which each may be protected by a screen, in some implementations. A vent 168 may also be disposed in the housing 162. An optional car sealing member and cushion 170 may be disposed on an outer portion of the housing 162 and adjacent the one or more speakers 164. An opening 172 through the optional car sealing member and cushion 170 allows sound to pass through the opening 172 to a user's ear drum. A stem 174 may extend below a main portion of the housing 162.

In various implementations, the housing 142 and/or 162 may also include fewer openings or additional openings, speakers 144 and/or 164, and microphones 146 and/or 166. Additional openings may include openings for one or more additional audio input devices (e.g., microphones), one or more pressure sensors, one or more light sources, one or more light sensors, or other components that receive or provide signals from or to the environment external to the housing 142 and/or 162. Openings may be open ports or may be completely or partially covered with a permeable membrane or a mesh structure that allows air and/or sound to pass through the openings.

In one or more use cases, one or more of the speakers 144 and/or 164 may generate a speaker output based, for example, on a downlink communications signal or a device-generated or streaming audio signal. In one or more implementations, the speaker(s) 144 and/or 164 may be driven by an output downlink signal that includes far-end acoustic signal components from a remote device, such as the electronic device 110. In one or more use cases, while a near-end user is using the audio system 100 to input and/or transmit their own speech, ambient noise surrounding the user may also be present in the environment around the audio system 100. Thus, the microphones of audio system 100 may capture the user's own speech as well as the ambient sounds around the audio system 100.

Aspects of the subject technology described herein may be performed by one or more processors of the audio system 100, including for example, a processor inside the electronic device 110, a processor inside the audio device 140, and/or a processor inside the audio device 160.

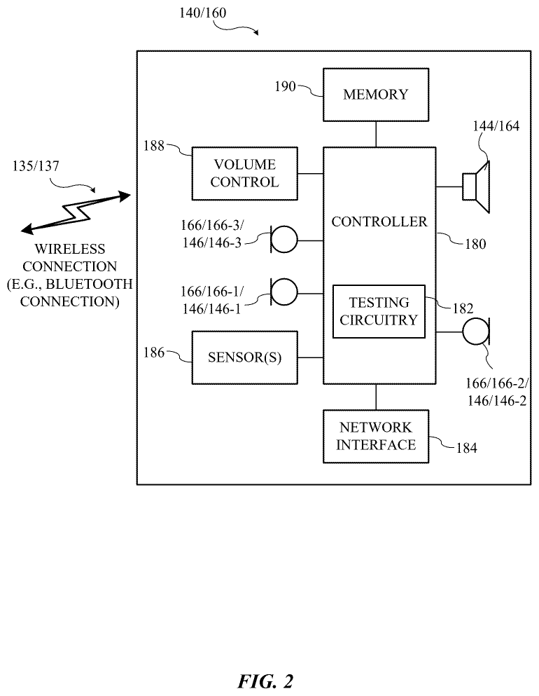

FIG. 2 illustrates details of the audio devices 140/160, in accordance with some implementations. Each of the audio devices 140/160 can include sensors (e.g., microphones) and emitters (e.g., speakers) as previously discussed. For example, an earbud audio device may have an inner sensor (which may be positioned inside an ear canal when worn by a user) microphone 146-1/166-1, a first outer sensor (which may be positioned outside the car canal when worn by the user, for example, for voice detection) microphone 146-2/166-2, a second outer sensor (which also may be positioned outside the car canal when worn by the user, for example, for ambient audio detection) microphone 146-3/166-3, and a primary speaker 144/164 for transducing an audio signal from an audio source into sounds audible to a user. The inner sensor may be an “error mic” used, for example, for acoustic noise cancellation (ANC). Each of the audio devices 140/160 can include a controller 180 and the controller may include testing circuitry 182 which may be specialized or general circuitry suitable to perform the operations described herein. Each of the audio devices may include a network interface 184 for providing one or more communication interfaces with another of the audio devices 140/160 or a primary control device, for example, via the wireless connection 135 and/or 137. Although the microphones 146 and 166 can be considered sensors, each of the audio devices 140 and/or 160 may include additional sensor(s) 186, for example, an accelerometer as part of an inertial measurement unit (IMU), a proximity sensor, or other sensors.

Each of the audio devices 140/160 may include a volume control 188 in accordance with some aspects. Each may also include memory 190. The controller 180 may be configured to perform data processing by receiving data via the various sensors and network interface 184, and outputting data via the emitter 144/164 and network interface 184.

In other aspects of FIG. 2, the audio devices 140/160 are not limited to earbuds; an audio device 140/160 may include other types of audio input and output devices, such an over- the-car audio headset, personal microphones, phones, tablets, watches, head mounted displays, and the like. In another aspect of FIG. 2, an audio device 140/160, may include different numbers of speakers and sensors.

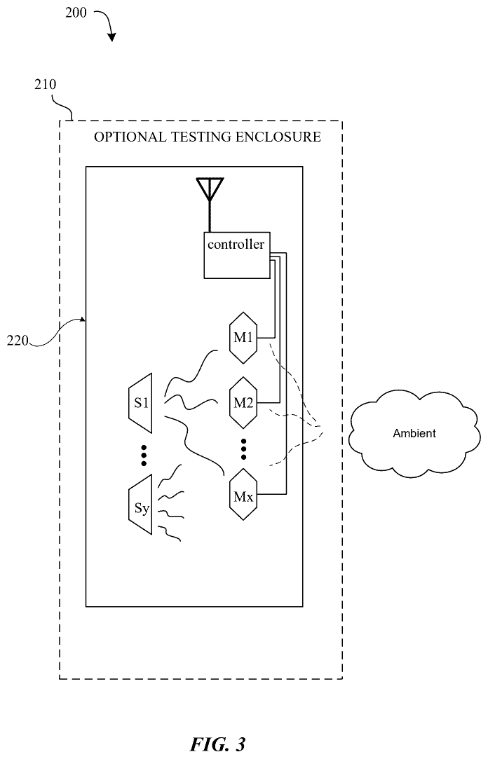

FIG. 3 illustrates a testing environment 200, in accordance with some aspects. The testing environment may include a testing optional enclosure 210 and an audio device 220 to be tested. The audio device 220 may, for example, include the audio device 140 or the audio device 160, either in their configuration as illustrated in FIG. 1 or in an alternative configuration, as described above, such as a watch, phone, tablet, head mounted display, and so forth. The audio device 220 can include one or more microphones M1, M2, . . . . Mx (Mx, for short) and one or more emitters, such as S1 . . . Sy (speakers Sy, for short). The audio device 220 can include a controller, such as the controller 180 described above and an antenna, for example, for transmitting data wirelessly over a network interface such as the network interface 184 over the wireless connection 135/137.

The optional enclosure 210 may include a vendor or third-party supplied item, such as a case specially designed to hold the audio device 220 when not in use or a case specially designed to perform acoustic testing. The optional enclosure 210 may also be a customer supplied item, such as a shoebox, a glass or plastic bin, tote, or tub, a cabinet, a drawer, or other enclosed space, and so forth. In some implementations, the optional enclosure 210 may not be used.

During a test, one or more of the speakers Sy may emit a test signal and one or more of the microphones Mx can each sense the test signal and provide a response curve based on the test signal. For example, if the transference were perfect, the output test signal would substantially equal the input response curve of the output test signal. Transference, however, depends on many factors, including for example, the acoustics of the optional enclosure 210 (if used), the placement of the one or more microphones Mx relative to the speakers Sy, the operational condition of the one or more microphones Mx, and interference caused by any ambient noise.

The test signal may be any suitable test signal. In an implementation, the test signal is ultrasonic such that it is not audible to human cars. In another implementation, the test signal is over a whole frequency range of the speakers Sy and/or one or more microphones Mx.

A base line test and frequency response can be determined for each audio device 220, as a general representation of such a manufacturing model of the audio device 220, as a specific implementation of a particular user's audio device 220, for example, which can be developed when the audio device 220 is put into service, or as both the general representation and specific implementation. The baseline test and frequency response data can be provided as training data to one or more machine learning models, such as discussed in greater detail below. For example, a machine learning model can be provided which has been trained using the general representation of the learning data for the manufacturing model and the machine learning model can be further trained after the audio device 220 has been deployed into service. Baseline test and frequency response data can be provided, during several testing sessions, for example, within the first few weeks or months of service.

The testing environment 200 may be configured so that the ambient noise is minimized. For example, an optional enclosure 210 may be arranged such that the walls of the enclosure dampen external noise that enters the testing environment 200. In another aspect, a testing time or place may be selected to minimize ambient noise. For example, a user of the audio device 220 may be instructed to place their audio device (within or without the optional enclosure 210) in a secluded area for a time period corresponding to the testing. In another example, the test may be conducted when the audio device 220 is docked in a case and charging and the case acts as the optional enclosure 210. The ambient noise of the environment can be measured as a part of the testing, for example, before emitting the test sounds over the speakers Sy, and a compensation offset applied to the response seen at the one or more microphones Mx.

After testing and controlling for the placement of the one more microphones Mx, the acoustics of the optional enclosure 210 (if used), and the interference caused by ambient noise, the resulting response can be used to estimate or predict the operational condition of the one or more microphone Mx and/or speakers Sy. For example, by comparing the transfer response of the one or more microphones Mx to each other, it can be determined whether a fault condition exists and if one exists, whether it is more likely that the fault condition is with one of the one or more microphones Mx or with one of the speakers Sy. For example, if a first of the one or more microphones Mx is showing a normal transfer response and a second of the one or more microphones Mx is showing a degraded or abnormal transfer response, then a fault condition can be determined with the second microphone. If both first and second microphones show a degraded or abnormal transfer response and they are degraded or abnormal similarly, then a fault condition can be determined with one of the speakers Sy. If both first and second microphones show a degraded or abnormal transfer response, and the degradation or abnormality is different in each, then the fault condition could be due to fault conditions with multiple components of the audio device 220 and more comparisons or testing may be needed, or a machine learning model having been trained on the baseline data can provide a prediction as to whether a fault condition is with each particular component of the audio device 220.

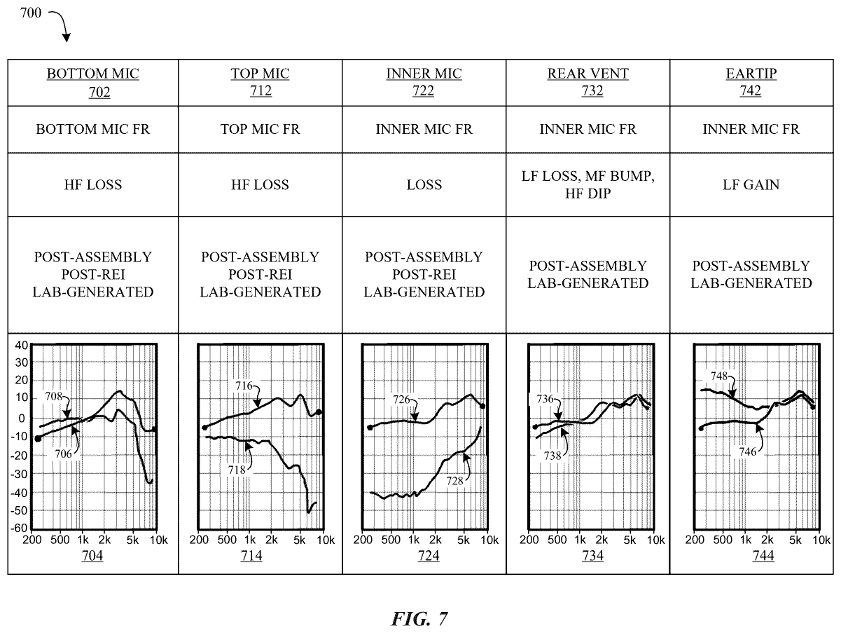

In some implementations, when a fault condition occurs, a type of fault condition can be determined from a machine learning model that has been trained on training data that includes transfer response data for simulated fault conditions. Examples of these are discussed in greater detail below with respect to FIG. 7.

In some implementations, when a fault condition occurs, the audio device 220 can note which of the components is predicted as having the fault condition and a hardware swap can be performed. The hardware swap can be performed using multiple modalities. In a first modality, the hardware swap can be performed on the audio device 220 itself. For example, the input from one microphone can logically be routed to the input of another microphone. If microphone M1 was determined to have a fault condition, for example, then the input of microphone M2 (or another microphone) can be routed to both the input of microphone M1 and microphone M2 (or the other microphone). The microphone selected as the replacement input may be selected based on its suitability for the function performed and/or based on the quality of its transfer response from the testing. For example, if the use of the microphone is for detecting ambient audio from an external microphone, then another external microphone input can be used. For example, if the use of the microphone is in the car for ANC, then an external ambient microphone input can be used. As another example, if the use of the microphone is for vocal input, then another external microphone or the inner (error correction) microphone can be used. In another modality, the input of the replacement microphone may be used in an application. For example, the audio device 220 may notify a paired control device (e.g., electronic device 110) and an application on electronic device 110 can use an alternative microphone input.

In some aspects, a first microphone of the audio device 220 may be a preferred microphone, such as for a given application. When a fault condition is determined for the first microphone, a second microphone on the audio device 220 may be made the preferred microphone.

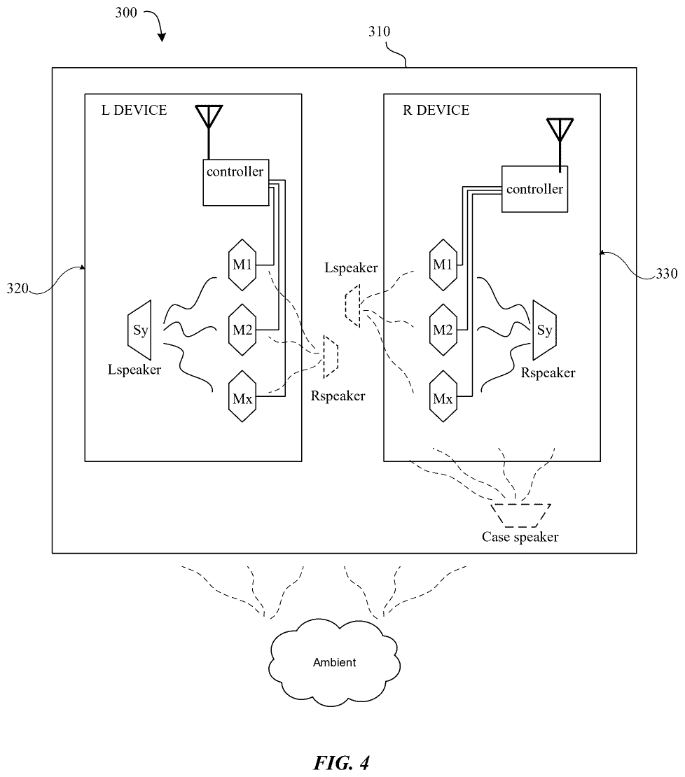

FIG. 4 illustrates a testing environment 300, in accordance with some aspects. The testing environment may include a testing enclosure 310 (e.g., case 120) and one or more audio devices 320 and 330 to be tested. The audio device 320 may, for example, include the audio device 140 or the audio device 160 and the audio device 330 may, for example, include the other of the audio device 140 or the audio device 160. Each of the audio devices 320 and 330 may be like unto the audio device 220, discussed above, and some features may not be illustrated for the sake of simplicity.

The enclosure 310 may include a docking charging case that is provided with the audio device 320 and 330. The enclosure 310 may include the features noted above with respect to the case 120. The enclosure 310, for example, may have cavities therein to hold the audio devices 320 and 330 which can close or be left open. In some implementations, the enclosure 310 may not be used.

During a test, one or more of the speakers Sy of each of the audio devices 320 and 330 may emit a test signal and the microphones Mx of each of the audio devices 320 and 330 can each sense the test signal and provide a response curve based on the test signal, in a similar manner as that discussed above with respect to FIG. 3. Because two audio devices 320 and 330 are positioned in the same enclosure 310, a test signal emitted on one of the audio devices 320 may be sensed on the microphones of the other of the audio devices 330, and vice versa. Then, in some aspects, this data can be provided back to the audio device 320 or 330 providing the test signal. This data can be used at the audio device 320 or 330 as one or more further data points to help it determine whether the emitter is operating correctly or is in a fault condition, and can be analyzed using similar techniques as those discussed above with respect to FIG. 3.

A further test can be performed by triggering an optional case speaker of the enclosure 310. The case speaker can emit a test signal which can be sensed by the one or more microphones Mx of the audio device 320 and/or 330. A transfer response can be measured at each of the one or more microphones Mx of the audio device 320 and/or 330 and analyzed. The analysis can include providing the transfer responses to one or more machine learning models trained on training data including baseline data, such as discussed above, e.g., for a general manufacturer model and for a specific implementation after deployment.

In some implementations, when a fault condition occurs, in addition to each of the audio devices 320 and/or 330 being able to switch microphones, also a microphone can be switched from a device of one of the audio devices 320 or 330 to a microphone of the other of the audio devices 320 or 330. For example, if microphone M1 of audio device 320 is determined to be in a fault condition, the input for the audio system encompassing both audio devices 320 and/or 330 may be switched to the microphone M1 of the audio device 330.

In some implementations, one of the audio devices 320 or 330 may be designated a primary device and is responsible for communicating with the control device (e.g., such as electronic device 110). In such implementations, a microphone Mx on the primary device may be designated as a preferred input or preferred microphone for a particular use on the control device, such as for a particular application or system process. When that preferred microphone is determined to be in a fault condition, another of the microphones of audio device 320 or 330 may be selected as the preferred microphone. In some implementations, when the microphone of the other audio device 320 and/or 330 is selected to be the preferred microphone, a primary device swap can occur such that what was the primary audio device is changed such that the other device becomes the primary device. For example, if the audio device 320 was the primary device, then the audio device 330 can be made the audio device when a microphone on the audio device 330 is selected as the preferred microphone.

In other implementations, each of the audio devices 320 and 330 may communicate with the control device (e.g., such as the electronic device 110), and so neither is a primary device. In other implementations, the roles need not swap and the microphone input which is made preferred (i.e., a microphone on an audio device 320 and/or 330 which is in a secondary role) is relayed through the primary device to the control device.

In some implementations, when a fault condition occurs with the preferred microphone, the control device (e.g., electronic device 110) can choose which input of all the microphones will be made the preferred input, and initiate a role swap for the audio devices 320 and 330 (if necessary and if implemented). In particular, the control device can be notified by the audio device 320 and/or 330 of the fault condition and receive data from each of the inputs of the audio devices 320 and 330 and choose from amongst all the available microphone inputs, which microphone input is best suited as a next-preferred or backup microphone for the audio devices 320 and 330 which are not in a fault condition.

In some implementations, the preferred microphone input can be selected between the two audio devices 320 and 330 and the control device (e.g., electronic device 110) may not perform the selection of the next preferred microphone. In such implementations, the audio devices 320 and 330 may also initiate a role change, e.g., from primary to secondary or secondary to primary, without input from the control device.

Although two audio devices 320 and 330 are illustrated in FIG. 4 and discussed above, it should be appreciated that additional audio devices may be implemented which may each also utilize input microphones. Further, it may be that the control device (e.g., electronic device 110) had one or more microphone inputs. In some instances, the control device may be considered part of the audio system (e.g., such as discussed above with respect to the audio system 100 of FIG. 1) and may provide an audio input using these techniques.

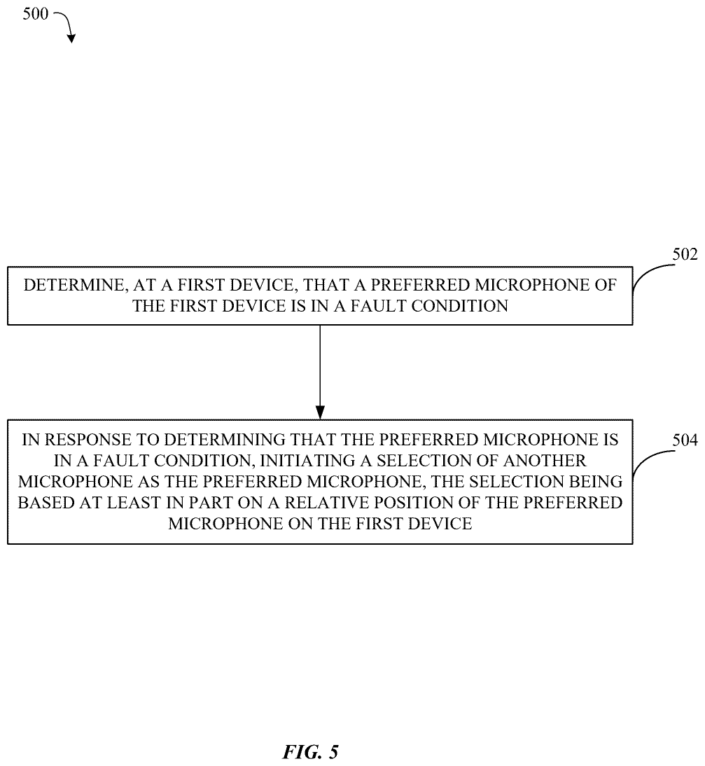

FIG. 5 illustrates a flow diagram for an example process 500 for determining a fault condition of a preferred microphone of a first audio device and switching the preferred microphone to another available microphone.

At step 502, the fault condition of the microphone of a first device may be determined. The determination, for example, may be made based on a testing of the audio system utilizing the techniques described above. In particular, in some implementations, an audio device may be docked in an audio device case. A test audio signal may be emitted from a speaker inside the case, such as from the audio device, and then in response the test audio signal may be received by a sensor inside the case, for example, the preferred microphone may receive the test audio signal. Based on the transfer response (i.e., transfer function) of the test audio signal, a determination may be made that the preferred microphone is in a fault condition.

In an example of the process 500, docking of an audio device may be detected by determining the first audio device is positioned in a cavity inside the case and that a lid of the case is in a closed position. The emitting speaker inside the case may be in a docked audio device, or may be part of the case itself. The test audio signal emitted by the speaker may be sourced from an audio source device, for example a cell phone paired via Bluetooth to an audio device or the case. The sensor receiving the emitted test audio signal may be any sensor in the case. For example, a test audio signal emitted by a speaker of a first audio device in the case may be received by a sensor also of the same first audio device. Alternatively, the test audio signal emitted by a speaker in a first audio device may be received by a sensor of a different second audio device. Additionally, an emitted test audio signal may be received by more than one sensor inside the case, such as by two sensors on the emitting device, or one sensor on two different audio devices.

The determination that the preferred microphone is in a fault condition may be made by comparing the transfer response of each of the sensor devices (microphones) to a baseline transfer response. The comparison may be made by understood statistical techniques, regressions, or analysis, in accordance with some implementations. In other implementations, the transfer response may be provided to one or more machine learning models trained on the baseline data, such as described above.

At step 504, in response to determining that the preferred microphone is in a fault condition, a selection of another microphone as the preferred microphone is initiated. The selection of the other microphone is based at least in part on a relative position of the preferred microphone on the first device. For example, the selection of another microphone for use as the preferred microphone may be based, in part, on a use case for the preferred microphone where the use case considers the location of the preferred microphone and attempts to utilize another microphone as the preferred microphone which meets the requirements of the use case, including a location for the microphone which will be made the preferred microphone. In another example, if a top microphone on the first device is determined to be in a fault condition, a bottom microphone of the first device may be selected as the preferred microphone in place of the top microphone. As noted above, the newly selected microphone to become the preferred microphone may be on the same audio device or may be on another audio device of the audio system which is communicatively coupled to the first audio device.

In accordance with some implementations, the selection of the alternative microphone as the preferred microphone may be further based on a condition of at least one other microphone of the first device. For example, if an alternative microphone of the first device is also in a fault condition, yet a different microphone may be selected as the preferred microphone, such as a microphone of a second device. In accordance with some implementations, the fault condition can be reported to a control device, such as a paired Bluetooth® device used to control the audio device. The control device may be configured to activate the other microphone as being the preferred microphone.

As noted above, in accordance with some implementations, prior to initiating the selection of the other microphone as the preferred microphone, the first device may have a primary role, and after initiating the selection of the other microphone as the preferred microphone, the second device may be elevated to the primary role. In accordance with some implementations, the other microphone made the preferred microphone may be determined at least in part by a use mode of a paired device. For example, rather than select another microphone on the same audio device, the use mode of the paired device (e.g., control device or electronic device 110), may determine that a better preferred microphone (as a backup microphone) may be located on a second audio device, and thus, may select the a microphone on the second audio device as the preferred microphone.

In some implementations, the determination made with respect to the fault condition of the preferred microphone of the first device may be performed when the first device is in an idle state. As noted above, this may be when the first audio device is docked in a charging case, however, this may also include those situations described above with respect to FIG. 3, such as when the device is in sleep mode, in an enclosure (with or without charging capabilities), or when a test process has been initiated and the device placed in a testing location.

In some implementations, the fault condition is determined by obtaining, at the first device, one or more transfer functions between at least one speaker of the first device and one or more microphones of the first device, and basing the determining of the fault condition at least in part by analyzing the one or more transfer functions. In some implementations, at least two of the one or more transfer functions can be compared, and a first alternative microphone may be selected when a corresponding transfer function indicates a better functionality of the first alternative microphone than another alternative microphone.

In some implementations, the one or more transfer functions may be applied to one or more trained machine learning models, and a prediction may be obtained from the one or more machine learning models that a microphone corresponding to each of the one or more transfer functions is in a fault condition. The one or more machine learning models may include a machine learning model for each transfer function of the one or more transfer functions. In some implementations, a prediction may be obtained from the one or more machine learning models of a categorization of a type of fault condition associated with each microphone predicted to be in the fault condition. Such fault conditions may be predicted to be water infiltration, moisture occlusion, dust or dirt occlusion, ear wax occlusion, and so forth.

In some implementations, the fault condition may be predicted to be an occlusion of one or more of a speaker opening, an upper microphone opening, an inner microphone opening, a lower microphone opening, or a rear vent opening of the first device.

In some implementations, an audio response can be obtained at a first device which is between at least one speaker of the first device and one or more microphones of a second device. The fault condition of at least one speaker or at least one microphone of the first device can be determined based at least in part on the audio response between the first device and the second device.

In an aspect, a received test audio signal may be used to determine a fault in an audio component of an audio device. A fault may include, for example, any change to the audio performance of any speaker or sensor in the audio device since a prior measurement of the faulty speaker or sensor. For example, the received test audio signal may be compared to test audio signals from a prior calibration; or the received test audio signal may be used to determine a transfer function of the audio system and the transfer function may be compared to a prior measurement of the transfer function (such as might be determined during a prior calibration). In one example, a reference or baseline transfer function for corresponding pairs of speakers and sensors inside a case may be determined during commissioning of the audio system as part of the manufacturing process, and then those reference transfer functions may be compared to corresponding new transfer functions determined during subsequent re-calibration processes.

In other aspects, analysis of received audio signal(s) may determine alternate types of faults, such as determining a partial or complete blocking of an audio port or vent for a speaker or sensor (such as by dirt, water (e.g., a temporary condition due to sweat or rain), or earwax), or determining damage to circuitry of the audio device (such as water damage due to prolonged exposure).

In an aspect, analysis of the received test audio signal may additionally be based on a determination of a configuration of an audio device or a configuration of a case. For example, some earbuds allow for attachment of sizing elements to alter the size or shape of an earbud to a particular user's ear. When such attachments may alter the received test audio signal (and alter a transfer function derived from the received test audio signal). In some aspects, a calibration process may determine what configuration an audio device under test is in (such as which sizing element is attached), and any identified fault or correction may be further based on the determined configuration. Similarly, a case may be in an open configuration, a closed configuration, or something other configuration, and a fault or correction determined by calibration may additionally be based on such a case configuration.

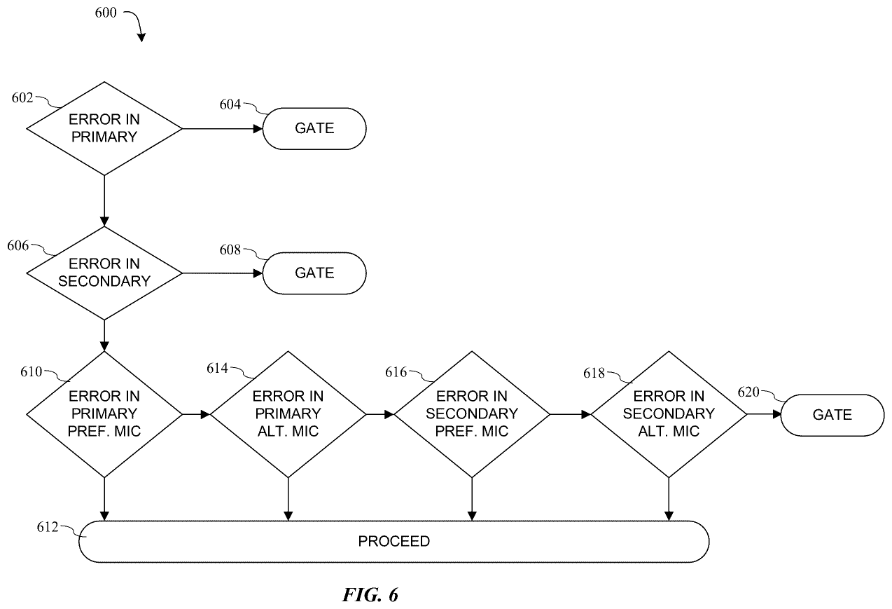

FIG. 6 illustrates a flow diagram for an example process 600 for gating a series of fault conditions of a primary audio device and secondary audio device of an audio system, in accordance with some implementations.

At block 602, a fault condition may be determined as being indicated in the playback system of the primary device. The playback system may include the speaker, a front vent, a rear vent, and an inner (error correction) microphone. If any of these items are occluded or in a failure mode or fault condition, then the playback system may be in a failure mode or fault condition. If so, then the flow may proceed to gate block 604. At block 604, then a response on a control device (such as a paired device) can be triggered. The response can include, for example, triggering the control device to provide, to the user, a message regarding the occlusion of the playback system, such as the speaker, front vent, rear vent, or inner mic, and instructions to the user to attempt to clear the occlusion(s). If no fault condition is indicated with the playback system of the primary device, then the flow proceeds to block 606.

At block 606, a fault condition may be determined as being indicated in the playback system of the secondary device. The playback system may include the speaker, a front vent, a rear vent, and an inner (error correction) microphone. If any of these items are occluded or in a failure mode or fault condition, then the playback system may be in a failure mode or fault condition. If so, then the flow may proceed to gate block 608. At 608, then a response on the control device can be triggered, such as described with respect to block 604, If no fault condition is indicated with the playback system of the secondary device, then the flow proceeds to block 610.

At block 610, if no fault condition is determined in the primary device preferred mic, then at block 612, usage of the audio device can proceed. If a fault condition is determined with the primary device preferred microphone, then the flow can proceed to block 614, and operation can failover to an alternate microphone on the primary device, in accordance with some implementations. If no fault condition is on the alternate microphone of the primary device, then usage of the audio device can proceed at block 612. If, at block 614, a fault condition is determined with the primary device alternate microphone, then the flow can proceed to block 616, and operation can failover to a preferred mic in a secondary device, in accordance with some implementations, and such as described above. If no fault condition is on the preferred microphone of the secondary device, then usage of the audio device can proceed at block 612. If a fault condition is determined with the secondary device preferred microphone, then the flow can proceed to block 618, and operation can failover to an alternate microphone on the secondary device, in accordance with some implementations. If no fault condition is on the preferred microphone of the secondary device, then usage of the audio device can proceed at block 612. If a fault condition is determined with the secondary device alternate microphone, then the flow can proceed to gating block 620, and the control device can be triggered. If no fault condition is on the alternate microphone of the second device, then usage of the audio system can proceed at block 612. The triggering of the control device may cause the control device to notify an application of an inability to proceed, notify a user of instructions on cleaning the audio system, or combinations thereof.

FIG. 7 illustrates a chart 700 with example frequency response data for different failure modes of an audio device, such as the audio device 140 and/or 160. The chart contains bottom mic information 702, top mic information 712, inner mic information 722, rear vent information 732, and car tip information 742. Each set of information also illustrates a corresponding transfer response chart 704, 714, 724, 734, and 744, according to various frequencies of a test signal. In each chart of charts 704, 714, and 724, the black line 706, 716, and 726 (the uppermost line) represents the nominal, baseline, or reference transfer response, while the red line 708, 718, and 728 (the lowermost line) represents the as-tested transfer response. As indicated in chart 704, an occlusion in the bottom mic may result in a loss of transfer of high frequencies while a slight increase of transfer at low frequencies. As indicated in chart 714, an occlusion in the upper mic may result in a loss of transfer across the entire frequency spectrum with a loss especially pronounced in the high frequencies. As indicated in chart 724, an occlusion in the inner mic may result in a loss of transfer across the entire frequency spectrum, with a loss especially pronounced in the low and mid-range frequencies.

In chart 734, the nominal, baseline, or reference transfer response is represented by the black line 736 and the as-tested transfer response is represented by the red line 738. As indicated in chart 734, an occlusion of the rear vent may result in a low frequency transfer loss, a mid-frequency transfer bump, and a high-frequency transfer dip. In chart 744, the nominal, baseline, or reference transfer response is represented by the black line 746 and the as-tested transfer response is represented by the red line 748. As indicated in chart 744, an occlusion of the car tip (e.g., speaker opening) may result in a low frequency transfer gain.

Each of the charts in FIG. 7 can be understood as representing a type of failure mode which can be used for training one or more machine learning models. For example, in accordance with some implementations, a machine learning model can be provided for each failure mode and a transfer response from a test can be provided to each trained machine learning model for comparison. Each machine learning model can then provide, based on the training data and the input transfer response, a probability that the transfer response corresponds to the failure mode. For example, additional failure modes and corresponding training data can be provided for water infiltration, water damage, dust, deformations, and partial occlusions. These can be added to one of the machine learning models or can be used to train additional machine learning models. Thus, the transfer response may be submitted to each machine learning model to determine if the failure mode corresponding to that machine learning model is predicted. In other aspects, the machine learning models can be split up by function, for example, including training for all failure modes for a particular component of the audio devices into each machine learning model. As such, when the transfer response is provided to each machine learning model, a prediction can be provided whether that component is in failure. Implementation in such separable machine learning models saves processing resources because each model is simplified, thereby extending battery life and saving system resources. In other aspects, all the training data can be provided to another machine learning model and the machine learning model can provide responses for failure predictions based on specific queries for each particular component of the audio device.

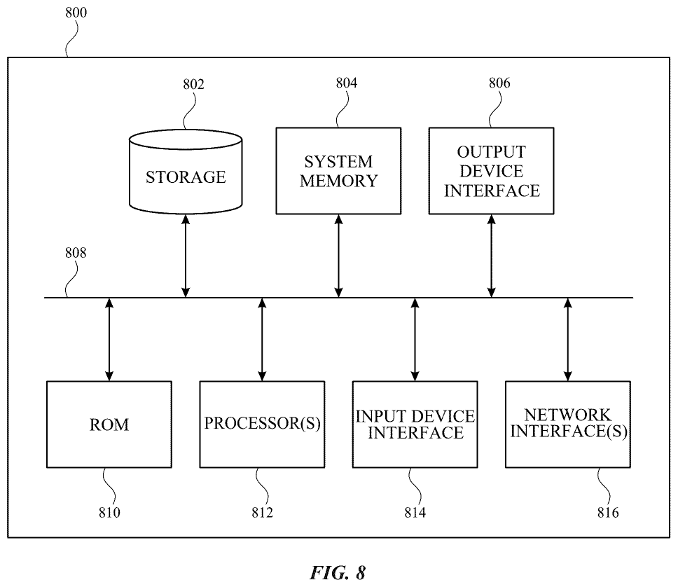

FIG. 8 illustrates an example computing device 800 with which aspects of the subject technology may be implemented in accordance with one or more implementations. In particular, each of the audio devices 140 and/or 160, and electronic device 110 may implement some or all of the computing device(s) described herein. The computing device 800 can be, and/or can be a part of, any computing device or server for generating the features and processes described above, including but not limited to a laptop computer, a smartphone, a tablet device, a wearable device such as a goggles or glasses, an earbud or other audio device, a case for an audio device, and the like. The computing device 800 may include various types of computer readable media and interfaces for various other types of computer readable media. The computing device 800 includes a permanent storage device 802, a system memory 804 (and/or buffer), an input device interface 814, an output device interface 806, a bus 808, a ROM 810, one or more processing unit(s) 812, one or more network interface(s) 816, and/or subsets and variations thereof.

The bus 808 collectively represents all system, peripheral, and chipset buses that communicatively connect the numerous internal devices of the computing device 800. In one or more implementations, the bus 808 communicatively connects the one or more processing unit(s) 812 with the ROM 810, the system memory 804, and the permanent storage device 802. From these various memory units, the one or more processing unit(s) 812 retrieves instructions to execute and data to process in order to execute the processes of the subject disclosure. The one or more processing unit(s) 812 can be a single processor or a multi-core processor in different implementations.

The ROM 810 stores static data and instructions that are needed by the one or more processing unit(s) 812 and other modules of the computing device 800. The permanent storage device 802, on the other hand, may be a read-and-write memory device. The permanent storage device 802 may be a non-volatile memory unit that stores instructions and data even when the computing device 800 is off. In one or more implementations, a mass-storage device (such as a magnetic or optical disk and its corresponding disk drive) may be used as the permanent storage device 802.

In one or more implementations, a removable storage device (such as a floppy disk, flash drive, and its corresponding disk drive) may be used as the permanent storage device 802. Like the permanent storage device 802, the system memory 804 may be a read-and-write memory device. However, unlike the permanent storage device 802, the system memory 804 may be a volatile read-and-write memory, such as random-access memory. The system memory 804 may store any of the instructions and data that one or more processing unit(s) 812 may need at runtime. In one or more implementations, the processes of the subject disclosure are stored in the system memory 804, the permanent storage device 802, and/or the ROM 810. From these various memory units, the one or more processing unit(s) 812 retrieves instructions to execute and data to process in order to execute the processes of one or more implementations.

The bus 808 also connects to the input and output device interfaces 814 and 806. The input device interface 814 enables a user to communicate information and select commands to the computing device 800. Input devices that may be used with the input device interface 814 may include, for example, alphanumeric keyboards and pointing devices (also called “cursor control devices”). The output device interface 806 may enable, for example, the display of images generated by computing device 800. Output devices that may be used with the output device interface 806 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 8, the bus 808 also couples the computing device 800 to one or more networks and/or to one or more network nodes through the one or more network interface(s) 816. In this manner, the computing device 800 can be a part of a network of computers (such as a LAN, a wide area network (“WAN”), or an Intranet, or a network of networks, such as the Internet. Any or all components of the computing device 800 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components (e.g., computer program products) and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
determining, at a first device, that a preferred microphone of the first device is in a fault condition; and
in response to determining that the preferred microphone is in a fault condition, initiating a selection of another microphone as the preferred microphone, the selection being based at least in part on a relative position of the preferred microphone on the first device.

2. The method of claim 1, wherein the selection is further based on a condition of at least one other microphone of the first device.

3. The method of claim 2, wherein the other microphone is disposed on a second device communicatively coupled to the first device.

4. The method of claim 3, further comprising:
reporting the fault condition to a control device paired with the first device, the control device being configured to activate the other microphone as the preferred microphone.

5. The method of claim 3, wherein prior to initiating the selection of the other microphone as the preferred microphone, the first device has a primary role, and wherein after initiating the selection of the other microphone as the preferred microphone, the second device is elevated to the primary role.

6. The method of claim 1, wherein the preferred microphone is determined by a use mode of a paired device.

7. The method of claim 1, further comprising:
initiating the determining that the preferred microphone is in the fault condition while the first device is in an idle state.

8. The method of claim 1, wherein determining that the preferred microphone is in the fault condition is initiated while the first device is positioned in an enclosure.

9. The method of claim 8, wherein the enclosure comprises a charging case.

10. The method of claim 1, wherein the fault condition is determined by obtaining, at the first device, one or more transfer functions between at least one speaker of the first device and one or more microphones of the first device, and basing the determining of the fault condition at least in part by analyzing the one or more transfer functions.

11. The method of claim 10, further comprising:
comparing at least two of the one or more transfer functions; and
selecting a first alternative microphone when a corresponding transfer function indicates a better functionality of the first alternative microphone than another alternative microphone.

12. The method of claim 10, further comprising:
applying the one or more transfer functions to one or more machine learning models; and
obtaining from the one or more machine learning models, a prediction that a microphone corresponding to each of the one or more transfer functions is in a fault condition.

13. The method of claim 12, wherein the one or more machine learning models correspond to a machine learning model for each transfer function of the one or more transfer functions.

14. The method of claim 12, further comprising:
obtaining from the one or more machine learning models, a prediction of a categorization of a type of fault condition associated with each microphone predicted to be in the fault condition.

15. The method of claim 12, wherein the fault condition is predicted to be an occlusion of one or more of a speaker opening, an upper microphone opening, an inner microphone opening, a lower microphone opening, or a rear vent opening of the first device.

16. The method of claim 1, further comprising:
in response to determining that a fault condition is indicated in at least one speaker of the first device, triggering a response on a control device paired with the first device.

17. The method of claim 16, further comprising:
in response to determining that a fault condition is indicated in at least a second speaker of a second device, triggering a second response on the control device, wherein the second device is communicatively coupled to the first device; and
in response to determining that a fault condition of the preferred microphone is indicated, a fault condition of a second microphone of the first device is indicated, a fault condition of a third microphone of the second device is indicated, and that a fault condition of a fourth microphone of the second device is indicated, triggering a response on the control device.

18. The method of claim 1, further comprising:
obtaining, at a first device, an audio response between at least one speaker of the first device and one or more microphones of a second device; and
determining a fault condition of at least one speaker or at least one microphone of the first device based at least in part on the audio response between the first device and the second device.

19. A device comprising:
a processor;
a computer-readable medium storing instructions thereon which when executed cause the processor to:
determine, at a first device, that a preferred microphone of the first device is in a fault condition; and
in response to determining that the preferred microphone is in a fault condition, initiate a selection of another microphone as the preferred microphone, the selection being based at least in part on a relative position of the preferred microphone on the first device.

20. A computer-readable medium storing instructions thereon, which when executed by one or more processors, cause the one or more processors to:
determine, at a first device, that a preferred microphone of the first device is in a fault condition; and
in response to determining that the preferred microphone is in a fault condition, initiate a selection of another microphone as the preferred microphone, the selection being based at least in part on a relative position of the preferred microphone on the first device.
